(19) United States
(12) Patent Application Publication
(10) Pub. No.: US 2012/0309391 A1
(43) Pub. Date: Dec. 6, 2012

(54) METHODS AND APPARATUS FOR ADAPTIVE NETWORK SELECTION

(76) Inventors: Qin Zhang, Mountain View, CA (US); Jianxiong Shi, Cupertino, CA (US)

(21) Appl. No.: 13/153,255

(22) Filed: Jun. 3, 2011

(51) Int. Cl. H04W 48/18; H04W 60/00; H04W 8/08

(52) U.S. Cl. 455/432.1; 455/434; 455/435.2

(57) ABSTRACT

Methods and apparatus enabling dynamic and adaptive network selection. In one embodiment of the invention, a device quickly identifies the a subset of networks providing service to a particular location without obtaining and/or prioritizing a full list of all available networks. A “highest” priority network is selected for registration. For example, a mobile device that cannot locate its home (or last registered) network (e.g., Public Land Mobile Network (PLMN)), searches for any available network. The mobile device can identify its current location from information broadcast by any networks (e.g., a Mobile Country Code (MCC)). Once the mobile has identified its current location, it searches for prioritized networks within its current location.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates generally wireless systems such as cellular networks. More particularly, in one exemplary aspect, the present invention is directed to methods and apparatus for adaptive network selection.

2. Description of Related Technology

A Public Land Mobile Network (PLMN) is a network that is established and operated by a cellular network operator to provide mobile telecommunications services to the public. Each cellular network operator providing mobile services has its own PLMN. PLMNs interconnect with other PLMNs and Public switched telephone networks (PSTN) for telephone communications or with Internet Service Providers (ISPs) for data and interne access.

Each PLMN is identified by a Mobile Country Code (MCC) and a Mobile Network Code (MNC). For example, AT&T Mobility™ has a MCC of 310 (United States) and several regional MNCs: 150, 170, 380, 410, and 560. Currently, there are several hundred different PLMN codes across the world. Since cellular technology is a high growth technology, this number is expected to increase with time.

Cellular service differentiates between a Home PLMN (HPLMN) which is a network that a device is associated with (e.g., due to various business considerations), and a Visitor PLMN (VPLMN) which is a network that the device is visiting. A Registered PLMN (RPLMN) is the device's currently registered network (or the last successfully registered PLMN if the device is currently not registered), and may be either a HPLMN or VPLMN. During normal operation, a cellular device generally must select between multiple PLMNs to register for cellular network service. Existing devices search for all available PLMNs, and then prioritize the available PLMNs according to a set of rules. Currently, devices assign the RPLMN and/or HPLMN the highest priority, followed by user preferred PLMNs, network operator preferred PLMNs, and the remaining PLMNs according to received signal quality. Once prioritized, the cellular device attempts to register to the highest priority network, etc.

Unfortunately, existing solutions for PLMN selection are extremely inefficient. User equipment (UE) that is “waking up” in a new area must execute a static searching mechanism that is time consuming, especially in instances where the user travels outside of their HPLMN and/or RPLMN. Specifically, the UE executes a blind search in all bands and all Radio Access Technologies (RATs) to compile a list of all available PLMNs. The UE will then select the highest priority PLMN out of the available PLMN list and attempt to connect to the selected PLMN. Accordingly, what is needed is a more efficient PLMN selection strategy. Ideally, such a strategy will adapt its PLMN selection to quickly identify the highest priority PLMN and acquire service. Furthermore, optimal solutions should generally not rely on assistance from other non-cellular technologies (although assisted variations may also be desirable in certain use scenarios).

### SUMMARY OF THE INVENTION

The present invention satisfies the aforementioned needs by providing, inter alia, improved apparatus and methods for adaptive network selection.

In one aspect of the present invention, a method for optimizing searches for a prioritized network from a plurality of networks is disclosed. In one embodiment, the method includes: receiving a message including at least one indicator of a current location of a first network; identifying a subset of second networks, based at least in part on the at least one indicator; and searching for the prioritized network based at least in part on the subset of second networks.

In one variant, the act of identifying includes querying a memory including associations between a plurality of indicators and a plurality of second networks.

In a second variant, the subset of second networks is prioritized, and the prioritized network is the highest priority network of the subset of second networks.

In a third variant, the at least one indicator of a current location includes a Mobile Country Code (MCC). Moreover, the subset of second networks may include Public Land Mobile Networks (PLMN) associated with the MCC. Still further, the mobile device may also include a memory storing an association of PLMNs and MCCs.

In a second aspect of the invention, a mobile apparatus is disclosed. In one embodiment, the mobile apparatus is configured to identify and connect to a prioritized network from a plurality of networks, and includes: a first wireless interface configured to receive at least an indicator of the current geographic location; a user interface; a storage device, the storage device comprising at least a plurality of information associating individual ones of a plurality of geographic locations to one or more of a respective plurality of available networks; and a processor configured to run at least one computer program thereon.

In one variant, the at least one computer program is configured to, when executed: utilize the indicator to generate a first association from the plurality of information at the storage device, the association comprising a subset of networks from the plurality of networks; and cause the apparatus to search the subset of networks.

In another variant, the subset of networks is further prioritized. Such prioritization can be based at least in part on a business consideration. In some variants, the storage device is pre-stored with the plurality of information.

In a third aspect of the invention, a computer-readable apparatus is disclosed. In one embodiment, the computer-readable apparatus is adapted to store a computer program, the computer program which, when executed, selects a network based on a current geographic location by: evaluating information identifying the current geographic location; based on the evaluation, using information stored at a storage device in communication with the apparatus to identify a preferred network therefor; and accessing the identified preferred network.

In a first variant, the evaluating includes detecting any network broadcasting an indicator identifying the current geographic location. In one implementation, the indicator includes a country code, and/or the network includes a cellular network.

In a second variant, the storage device includes a Subscriber Identity Module (SIM). Moreover, the SIM includes an association of Public Land Mobile Networks (PLMNs) with Mobile Country Codes (MCCs). In some cases, the PLMNs are prioritized or alternately, may be evaluated based on received signal quality.

In yet another variant, identifying the current geographic location includes decoding a broadcasted MCC, or in some cases receiving the current geographic location from a user input.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1 is a logical flow diagram illustrating an exemplary prior art method for network selection.

FIG. 2 is a logical flow diagram illustrating one embodiment of a generalized method for adaptive network selection, in accordance with the present invention.

FIG. 3 is a logical flow diagram illustrating one exemplary implementation of the generalized method of FIG. 2.

FIG. 4 is a block diagram of an exemplary apparatus useful for implementing the methods of the present invention.

All Figures Copyright 2011 Apple Inc. All rights reserved.

### DETAILED DESCRIPTION OF THE INVENTION

Reference is now made to the drawings, wherein like numerals refer to like parts throughout.

### Overview

In one aspect, the present invention provides methods and apparatus for providing a dynamic and adaptive network selection strategy. In one embodiment (in a cellular telephony context), various aspects of the present invention allow for quick identification of an appropriate Public Land Mobile Network (PLMN) providing service within a particular location without obtaining and/or prioritizing a full list of all available PLMNs. In some variants, the present invention identifies the highest priority PLMN that is available. As described in greater detail hereinafter, the aforementioned selection strategy can be employed e.g., when the device fails to locate its Home PLMN (HPLMN) or last Registered PLMN (RPLMN). One implementation of the invention advantageously does not require assistance from other non-cellular technologies, and can be implemented within existing network infrastructures and messaging protocols.

In one configuration, a mobile device has pre-stored information associating geographic information with one or more networks. When the mobile device needs to establish a connection to a new network (e.g., when the device has left a geographic area for which service was available under previous network connections), the device determines its current location, and accesses the pre-stored information to select the appropriate network for the device's current location.

For example, a user equipment (UE) may have pre-stored within internal memory (or Subscriber Identity Module (SIM)), a table associating acceptable Public Land Mobile Networks

(PLMNs) with Mobile Country Codes (MCCs). If the UE cannot find its last known PLMN, the UE searches for any PLMN, identifies its associated MCC, and narrows its subsequent searches for appropriate PLMNs associated with that MCC.

### Detailed Description of Exemplary Embodiments

Exemplary embodiments and aspects of the present invention are now described in detail. While these embodiments and aspects are primarily discussed in the context of Subscriber Identity Modules (SIMs) of a GSM, GPRS/EDGE, or UMTS cellular network, it will be recognized by those of ordinary skill that the present invention is not so limited. In fact, the various aspects of the invention are useful in any wireless network (whether cellular or otherwise) that can benefit from the dynamic network selection strategy described herein.

It will also be recognized that while the selection strategy described herein focuses primarily on using a detected Mobile Country Code (MCC) broadcast from any arbitrary source to quickly determine and connect to a preferred network, the present invention is not so limited. In fact, the various aspects of the invention can utilize other cellular (and even non-cellular) data to quickly identify and connect to a preferred network. For example, various embodiments of the present invention may be coupled to other forms of geographic determination (e.g., Global Positioning System (GPS), Assisted GPS (A-GPS), association with a known WLAN AP, user input, etc.), where the geographic determination is associated with a limited subset of entities (e.g., PLMNs).

### Prior Art Public Land Mobile Network (PLMN) Selection

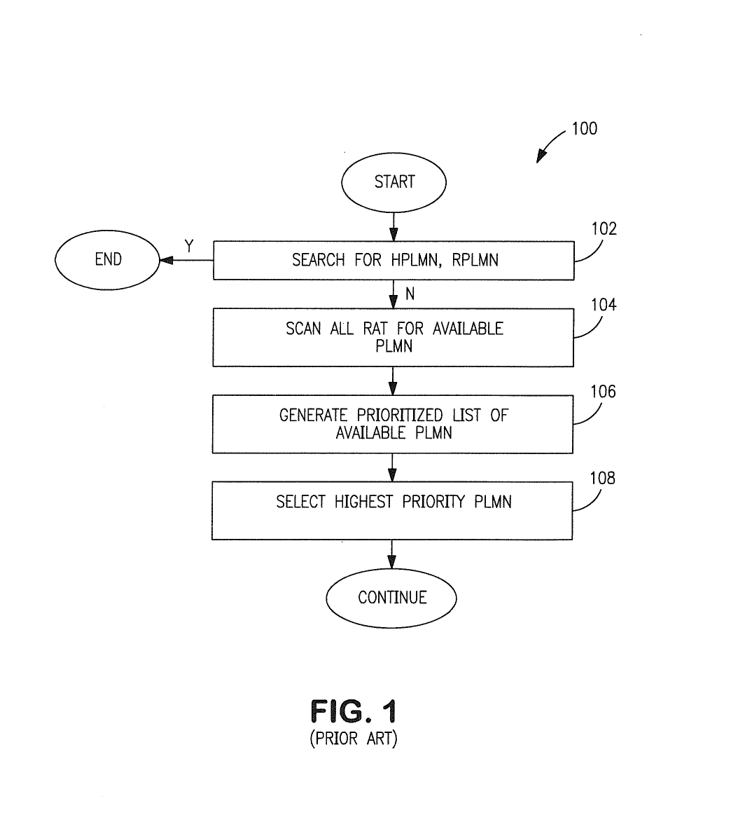

As illustrated in FIG. 1, the conventional PLMN selection strategy is static (i.e., execution does not change according to known (or unknown) considerations). At step 102 of the method 100 of FIG. 1, the mobile device is powered up and searches for the last or current Registered PLMN (RPLMN) and/or the UE's Home PLMN (HPLMN). If either the last RPLMN or HPLMN is found, then the device can proceed to normal registration. However, if the last/current PLMN (i.e. the RPLMN or HPLMN) is not found, then per step 104, the UE scans all bands for available Radio Access Technologies (RATs) (also commonly referred to as a “blind search”). The resulting list of available PLMNs is sorted into a prioritized list of available PLMNs (step 106). Thereafter, the highest priority PLMN is selected for use at step 108. The remaining PLMNs may be accessed if needed, in accordance with the prioritized list.

In the context of the 3^{rd} Generation Partnership Project (3GPP), PLMNs are prioritized as follows. The RPLMN/HPLMN (or its equivalent) has the highest priority followed by a user preferred PLMN. This is followed by the operator preferred PLMN, and finally by any randomly determined PLMNs. The randomly determined PLMNs are arranged by signal quality such that PLMNs with high signal quality are ranked ahead of PLMNs with lower signal quality.

### Methods

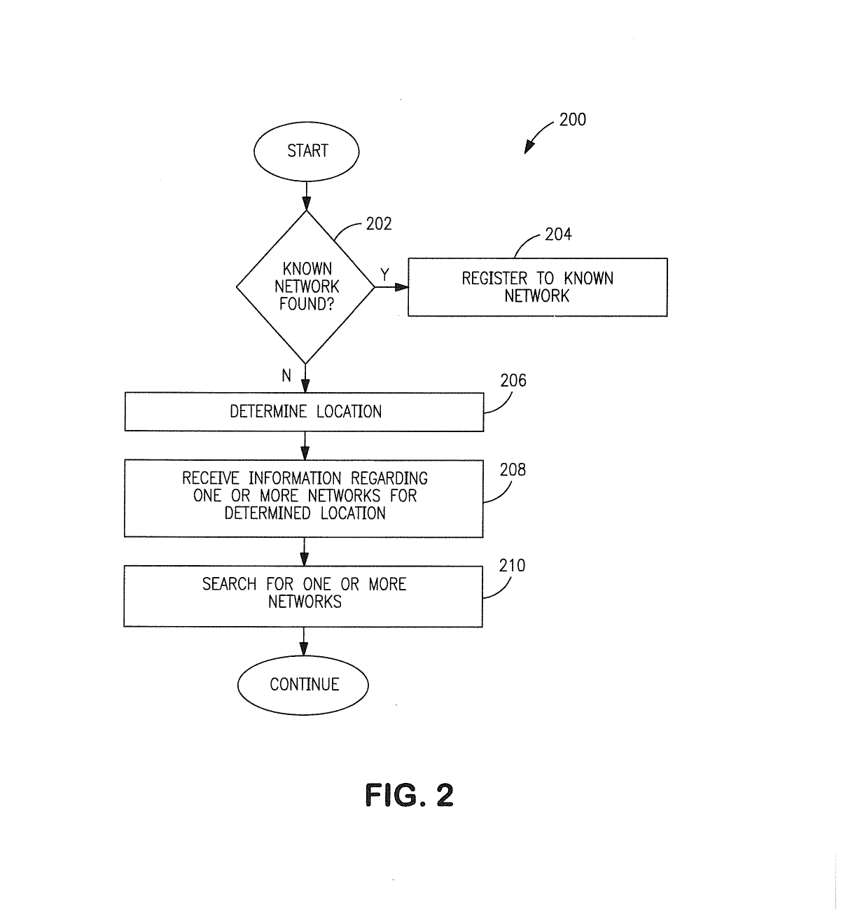

Referring now to FIG. 2, a generalized method for adaptive network selection in accordance with one embodiment of the present invention is illustrated.

As shown, at step 202 of the method 200, the mobile device searches for a known network. In one exemplary embodiment, the mobile device searches for its home network or last registered network (e.g., HPLMN, RPLMN, etc.). If a known network is found, then per step 204 the mobile device registers to the known network via prior art registration procedures.

In one exemplary embodiment, a user equipment (UE) searches for its Home Public Land Mobile Network (HPLMN), and/or its last Registered Public Land Mobile Network (RPLMN). For example, a Universal Mobile Telecommunications System (UMTS) UE decodes the Broadcast Control Channel (BCCH) which includes PLMN identifying information such as: Mobile Country Code (MCC), Mobile Network Code (MNC), etc. In fact, most cellular network technologies, such as inter alia, GSM (Global System for Mobile Communications), UMTS, and LTE (Long Term. Evolution), broadcast identifying information within analogous control channels.

If, however, the device cannot find its home network or last registered network, then the mobile device determines its current location (at step 206). In one exemplary embodiment, the location information can be determined by decoding information broadcast from one or more other networks. For example, a UE can decode the BCCH from any available UMTS network, to determine the MCC of the UMTS network to extract the Mobile Country Code (MCC), etc. Moreover, it is of note that the UE can decode the BCCH without registering with the network.

In alternate embodiments, the location information can be received from one or more secondary sources. For example, the device may receive input from a Global Positioning System

(GPS) transceiver that identifies the device's current location. In another such example, the device may receive a broadcast from a Wireless Local Area Network (WLAN) that identifies the WLAN network location (or alternatively, the location may be known for that WLAN node, and mere reception from or association with that node may be used to locate the mobile device). In still other examples, the device may simply accept user input (e.g., the user interface accepts a city and state, etc.).

In yet other embodiments, the mobile device may indirectly determine the current location. For example, the mobile device may estimate its current location based on last known location, last known direction of travel, and time.

At step 208, the mobile device retrieves pre-stored information identifying one or more networks for the determined location. Thereafter, the mobile device only searches for networks from the one or more identified networks. In one exemplary embodiment, the UE identifies one or more PLMNs associated with the determined MCC. For example, within any single country only a subset of all possible PLMNs are available. By reducing the search window to only the PLMNs available within that country, the UE can greatly reduce the number of searches.

Moreover, in some variants of the method, the mobile device further prioritizes its search within the identified one or more networks. For example, within the subset of PLMNs available within any single country, the UE may have contractual business arrangements with only a few PLMNs of that subset. In some cases, these business arrangements may be further arranged in order of preference, further streamlining the UE's search process (the UE searches for the most preferred PLMN; if the search is unsuccessful, the UE searches for the next most preferred PLMN, etc.).

At step 210 of the method 200, the mobile device searches for the identified one or more networks for the determined location and selects one network for registration. For example, once the UE has identified one or more PLMNs associated with the determined MCC, the UE searches for each of the identified PLMNs. The results of the UE's search are used by the UE to determine which PLMN to register with.

The UE may also register with PLMNs based on one or more business considerations. Alternatively, the UE may register with the PLMN that has the highest signal reception characteristics. In still other implementations, the UE may register with the PLMN according to selection by the user of the mobile device. Various combinations of the foregoing, and yet other schemes, will be readily recognized by ones of ordinary skill, given the contents of the present disclosure.

In contrast to the prior art methods for determining a network (see FIG. 1 above), the method of FIG. 2 advantageously does not require the mobile device to search all networks and perform a prioritization of the available networks. Instead, the mobile device of the exemplary embodiment of the present invention adapts is network searches based on geographic location information.

### Example Operation

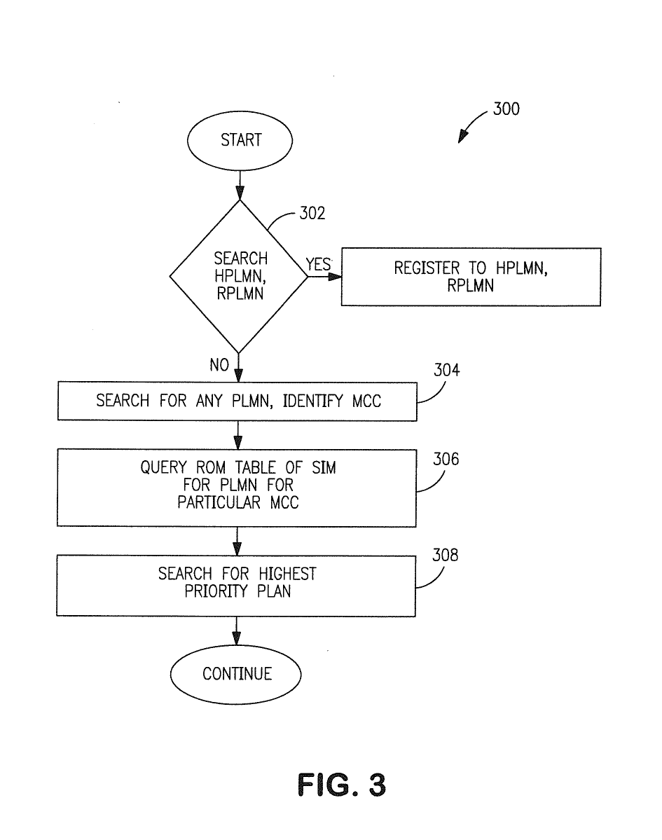

Referring now to FIG. 3, one exemplary implementation of the method for adaptive network selection of FIG. 2 is illustrated.

At step 302 of the method 300, a user equipment (UE) searches for its Home Public Mobile Land Network (HPLMN), and/or last Registered PLMN (RPLMN). For example, a user who lives in the San Francisco Bay Area owns a UE with an RPLMN/HPLMN that is part of the AT&T™ network (310-410). The user boards an airplane bound for London, England and powers off their UE. Upon arriving in London, the user powers on their UE. The UE initially attempts to locate the AT&T network.

Since the UE cannot locate its HPLMN (or RPLMN), the UE searches for any PLMN, and identifies the detected PLMN's Mobile Country Code (MCC), and Mobile Network Code (MNC) (step 304). Standards for the exemplary MCC are defined by the International Telecommunication Union (ITU) E.212 entitled “Operation, numbering, routing and mobile services—International operation—Maritime mobile service and public land mobile service” (November 1998), which is incorporated herein by reference in its entirety. The MCC uniquely identifies the country of the PLMN, whereas the MNC uniquely identifies the mobile network operator of the PLMN. For example, in this case, the UE discovers a Virgin® network (234-31). The UE can determine from the MCC (234) that the UE is operating within the United Kingdom.

Per step 306, the UE queries a storage area or device (e.g., a Read-only memory (ROM), etc.) resident on its Subscriber Identity Module (SIM) module for one or more PLMNs for the particular MCC. According to this embodiment, the SIM module has been pre-stored with a table that lists each MCC and associated PLMNs. Generally, these associations may be determined based on e.g., business consideration, network input, user input, etc. In this example, the user's SIM module was previously configured for dual operation within the United States of America (e.g., San Francisco Bay Area) and the United Kingdom (e.g., London). The user's SIM module is configured to operate with certain UK networks e.g., Orange networks (234-33, 234-34), and T-Mobile® networks (234-30). Moreover, in this example, the SIM module has also prioritized a “highest” priority PLMN.

The UE searches for the highest priority PLMN based on the retrieved information (step 308). For example, such information may include relevant frequency bands, control information, billing considerations, etc. The UE searches the frequency bands associated with appropriate networks. By focusing the search criteria, the UE minimizes the amount of searching required to identify an appropriate PLMN. Specifically, in contrast to prior art mechanisms (see e.g., description of FIG. 1 above) where the UE must search all possible Radio Access Technologies (RATs) for available PLMNs, the exemplary embodiment of the present invention enables an adaptive search based on initial information (e.g., results of a preliminary search). In fact, while the foregoing embodiment describes using the MCC to quickly narrow the UE's PLMN search criteria, it is appreciated that yet other forms of the present invention may be based on e.g., secondary inputs and/or user inputs. For example, alternate embodiments may retrieve information from a secondary Global Positioning System (GPS) receiver, prompt the user for a current city, etc.

Generally, the memory table will store more than one PLMN for each MCC (although some implementations may be limited to a single PLMN). Additionally, the memory table may prioritize one or more PLMNs in order of preference. Accordingly, when the preferred or highest ranked PLMN is not available or cannot be accessed, the next preferred PLMN is attempted, etc. In one variant, only certain MCC may be provided multiple PLMN, these MCC being selected based on e.g., popularity, necessity (i.e., multiple networks are necessary because often PLMN fail or are inaccessible), etc.

It is also appreciated that the present invention contemplates the ability for the priority structure of PLMNs to change or vary dynamically, such that the most preferred PLMN in one geographic region, time period, operating mode, etc. may not be the most preferred in others. Stated differently, it is contemplated that the operating context of the user/device may be used as input to an algorithm which dynamically ranks or orders the priority for different PLMNs.

Once the UE has successfully found the highest priority PLMN, the UE can execute normal cellular registration procedures.

### Apparatus

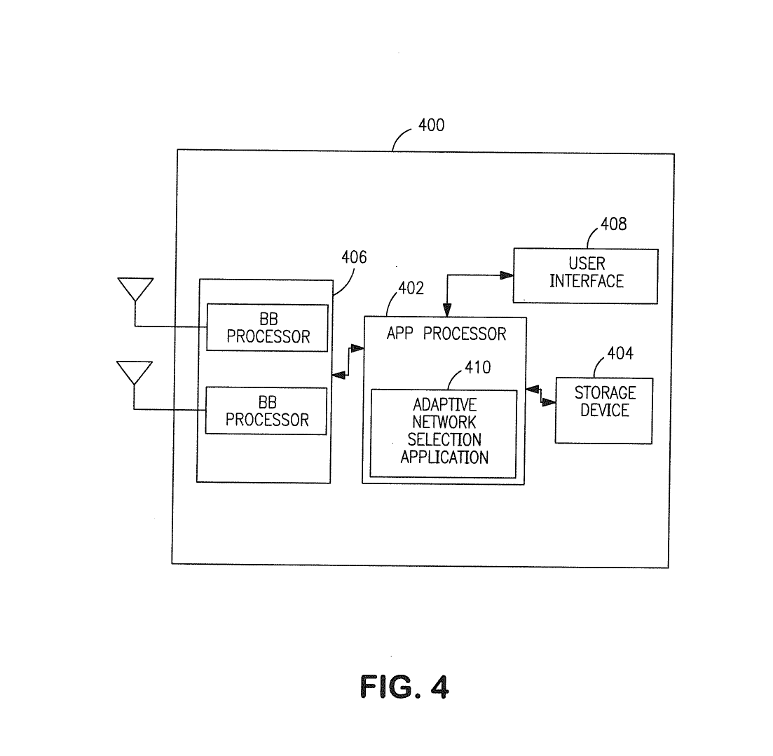

Referring now to FIG. 4, exemplary user or client mobile apparatus 400 implementing various aspects of the present invention is illustrated.

The exemplary UE 400 apparatus of FIG. 4 is a wireless device with a processor subsystem 402 such as a digital signal processor, microprocessor, field-programmable gate array, or plurality of processing components mounted on one or more substrates. The processing subsystem 402 may also include an internal cache memory. The processing subsystem 402 is connected to a memory subsystem 404 comprising memory which may for example, include SRAM, flash and SDRAM components. The memory subsystem 404 may implement one or a more of DMA type hardware, so as to facilitate data accesses as is well known in the art. The memory subsystem 404 contains computer-executable instructions which are executable by the processor subsystem 402.

In one exemplary embodiment, the device can include of one or more wireless interfaces (406) adapted to connect to one or more wireless networks. The multiple wireless interfaces 406 may support different radio technologies such as GSM, CDMA, UMTS, LTE/LTE-A, WiMAX, WLAN, Bluetooth, etc. by implementing the appropriate antenna and modem subsystems.

The user interface subsystem 408 includes any number of well-known I/O including, without limitation: a keypad, touch screen (e.g., multi-touch interface), LCD display, backlight, speaker, and/or microphone. However, it is recognized that in certain applications, one or more of these components may be obviated. For example, PCMCIA card-type client embodiments may lack a user interface 408 (as they could piggyback onto the user interface of the host device to which they are physically and/or electrically coupled).

Moreover, in the illustrated embodiment, the apparatus further contains a adaptive network selection application 410 which when executed by the processor subsystem 402: (i) searches for one or more first networks, (ii) if the one or more first networks are not found, then determines its current location, (iii) identifies one or more second networks for the determined location, and (iv) searches for the one or more second networks (see also, FIGS. 2 & 3 and related discussions).

In other variants, the foregoing procedure may be coded into logic circuitry, and/or embodied within other hardware modules. Furthermore, while the foregoing embodiment illustrates the adaptive network selection application 410 resident to the processing subsystem, it will be appreciated by those of ordinary skill in the related arts that such computer-executable instructions may be equally stored within the memory subsystem, or even removable media (e.g., a Subscriber Identity Module (SIM) card, etc.).

In one variant, the memory subsystem 404 further includes information associating one or more PLMNs for each MCC. Alternatively, the memory subsystem 404 may be in communication with an apparatus having such an association stored thereon (such as e.g., the SIM module discussed above). Furthermore, in certain implementations, the information may be further prioritized or preferenced, according to various considerations including, but not limited to: business considerations, user considerations, applications, historical use, etc. Moreover, such associations may be configured/re-configured as desired. For example, a user wishing to modify their service contract may add/subtract/modify service contracts with other network carriers, etc. In some cases these associations may have certain restrictions on use (e.g., expiration dates, limits on use, etc.)

Still further, it is appreciated that various aspects of the present invention may be overriden and/or leveraged by various regulatory requirements. For example, during a so-called “emergency call”, the mobile device may be required to use any PLMN (e.g., the mobile device may be forced to do a “blind search”). Alternately, during an emergency call, the mobile device may be required to use a specific PLMN, follow a prescribed sequence or hierarchy (which may be different than that which it would use otherwise), etc.

While the foregoing embodiment of the user device 400 is described primarily in the context of a mobile telephone (e.g., smartphone), it will be recognized the invention is in no way limited to telephony devices. For example, the foregoing techniques can be directly applied to data networks, such as e.g. a “4G” WiMAX or WLAN enabled device, such as a handheld or laptop computer.

Furthermore, while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for optimizing searches for a prioritized network from a plurality of networks, the method comprising:
receiving a message including at least one indicator of a current location of a first network;
identifying a subset of second networks, based at least in part on the at least one indicator; and
searching for the prioritized network based at least in part on the subset of second networks.

2. The method of claim 1, wherein the act of identifying comprises querying a memory comprising associations between a plurality of indicators and a plurality of second networks.

3. The method of claim 1, wherein the subset of second networks is prioritized, and the prioritized network is the highest priority network of the subset of second networks.

4. The method of claim 1, wherein the at least one indicator of a current location comprises a Mobile Country Code (MCC).

5. The method of claim 4, wherein the subset of second networks comprises Public Land Mobile Networks (PLMN) associated with the MCC.

6. The method of claim 5, wherein the mobile device comprises a memory storing an association of PLMNs and MCCs.

7. A mobile apparatus configured to identify and connect to a prioritized network from a plurality of networks, the apparatus comprising:
a first wireless interface configured to receive at least an indicator of the current geographic location;
a user interface;
a storage device, the storage device comprising at least a plurality of information associating individual ones of a plurality of geographic locations to one or more of a respective plurality of available networks; and
a processor configured to run at least one computer program thereon, the at least one computer program configured to, when executed:
utilize the indicator to generate a first association from the plurality of information at the storage device, the association comprising a subset of networks from the plurality of networks; and
cause the apparatus to search the subset of networks.

8. The apparatus of claim 7, wherein the subset of networks is further prioritized.

9. The apparatus of claim 7, wherein the subset of networks is prioritized based at least in part on a business consideration.

10. The apparatus of claim 7, wherein the storage device is pre-stored with the plurality of information.

11. A computer-readable apparatus comprising a medium adapted to store a computer program, the computer program which, when executed, selects a network based on a current geographic location by:
evaluating information identifying the current geographic location;
based on the evaluation, using information stored at a storage device in communication with the apparatus to identify a preferred network therefor; and
accessing the identified preferred network.

12. The apparatus of claim 11, wherein the act of evaluating comprises detecting any network broadcasting an indicator identifying the current geographic location.

13. The apparatus of claim 12, wherein the indicator comprises a country code.

14. The apparatus of claim 13, wherein the network comprises a cellular network.

15. The apparatus of claim 11, wherein the storage device comprises a Subscriber Identity Module (SIM).

16. The apparatus of claim 15, wherein the SIM comprises an association of Public Land Mobile Networks (PLMNs) with Mobile Country Codes (MCCs).

17. The apparatus of claim 16, wherein the associations are further prioritized.

18. The apparatus of claim 16, wherein the act of identifying a preferred network comprises evaluating a received signal quality.

19. The apparatus of claim 16, wherein the act of identifying the current geographic location comprises decoding a broadcasted MCC.

20. The apparatus of claim 16, wherein the act of identifying the current geographic location comprises receiving the current geographic location from a user input.
